(19) United States
(12) Patent Application Publication
(10) Pub. No.: US 2026/0160615 A1
(43) Pub. Date: Jun. 11, 2026

(54) A STRAIN MEASUREMENT DEVICE AND A STRAIN MEASUREMENT METHOD

(71) Applicant: OSAKA UNIVERSITY, Osaka (JP)

(72) Inventors: Daichi CHIBA, Osaka (JP); Ryo GENTA, Osaka (JP); Kento HASEGAWA, Osaka (JP)

(73) Assignee: OSAKA UNIVERSITY, Osaka (JP)

(21) Appl. No.: 18/716,786

(22) PCT Filed: Nov. 25, 2022
(86) PCT No.: PCT/JP2022/043566

§ 371 Date: Jun. 5, 2024

(30) Foreign Application Priority Data
Dec. 7, 2021 (JP) 2021--198498

(51) Int. Cl. G01L 1/12; G01L 1/22

(52) U.S. Cl. CPC G01L 1/12; G01L 1/22

(57) ABSTRACT

A strain measurement device (1) including: a substrate (10); a first element (21) formed on the substrate (10) and having a first magnetization layer, a second magnetization layer, and a first spacer layer; and a second element (22) formed on the substrate (10) and having a third magnetization layer, a fourth magnetization layer, and a second spacer layer. In a state where no strain is applied to the substrate (10), at least one magnetization direction out of the magnetization direction (31a) of the first magnetization layer, the magnetization direction (31c) of the second magnetization layer, the magnetization direction (32a) of the third magnetization layer, and the magnetization direction (32c) of the fourth magnetization layer is different from the other magnetization directions. Also provided is a strain measurement method using the strain measurement device.

### TECHNICAL FIELD

The present invention relates to a strain measurement device and a strain measurement method.

### BACKGROUND ART

Highly sensitive sensors that utilize magnetism in measuring strain have been developed in recent years.

For example, Patent Document 1 describes a stress sensor having a stress detection layer including a laminated body including a first magnetic layer, a first non-magnetic layer, and a second magnetic layer that are laminated, wherein the first magnetic layer and the second magnetic layer have mutually different magnetoelastic coupling constants, one of the first magnetic layer and the second magnetic layer is a strain-insensitive layer having a magnetoelastic coupling constant whose absolute value is 0.5 MJ/m³ or less, the other of the first magnetic layer and the second magnetic layer is a strain-sensitive layer having a magnetoelastic coupling constant whose absolute value is larger than that of the strain-insensitive layer, a relative angle of magnetization between the first magnetic layer and the second magnetic layer varies depending on externally applied stress, and a strain direction is detected by a change in electrical resistance depending on the relative angle and corresponding to the direction of the externally applied stress.

### RELATED ART DOCUMENT

### Patent Document

Patent Document 1: Japanese Patent No.6722304

### SUMMARY OF THE INVENTION

### Technical Problem

However, in the stress sensor described in Patent Document 1, a change in electrical resistance due to factors other than the change in magnetization direction occurs. Therefore, there has been a need to develop a device and method that can eliminate these factors and measure strain more accurately.

The present invention has been made in view of the aforementioned circumstances, and an object of the present invention is to provide a strain measurement device and strain measurement method for measuring strain more accurately than in the conventional art.

### Solutions to the Problems

The gist of one embodiment of a strain measurement device of the present invention is according to the present invention that can overcome the above problems is as follows.
[1] A strain measurement device comprising:
   a substrate;
   a first element formed on the substrate and having a first magnetization layer, a second magnetization layer whose change in a magnetization direction when strain is applied to the substrate is larger than that of the first magnetization layer, and a first spacer layer placed between the first magnetization layer and the second magnetization layer; and
   a second element formed on the substrate and having a third magnetization layer, a fourth magnetization layer whose change in a magnetization direction when strain is applied to the substrate is larger than that of the third magnetization layer, and a second spacer layer placed between the third magnetization layer and the fourth magnetization layer, wherein
   in a state where no strain is applied to the substrate, at least one magnetization direction out of the magnetization direction of the first magnetization layer, the magnetization direction of the second magnetization layer, the magnetization direction of the third magnetization layer, and the magnetization direction of the fourth magnetization layer is different from the other magnetization directions.

The strain measurement device having the above configuration can measure strain more accurately than in the conventional art by subtracting or dividing one of electrical resistances obtained from the first element and the second element from or by the other of the electrical resistances.

Preferred aspects of the strain measurement device of the present invention are as shown in the following [2] to [6]:
[2] The strain measurement device according to above [1], wherein
   the magnetization direction of the first magnetization layer when strain is applied to the substrate is within ±10° from the magnetization direction of the first magnetization layer when no strain is applied to the substrate, and
   the magnetization direction of the third magnetization layer when strain is applied to the substrate is within ±10° from the magnetization direction of the third magnetization layer when no strain is applied to the substrate.
[3] The strain measurement device according to above [1] or [2], wherein the at least one magnetization direction perpendicularly intersects the other magnetization directions.
[4] The strain measurement device according to any one of above [1] to [3], wherein the first spacer layer and the second spacer layer are each made of an insulator.
[5] The strain measurement device according to any one of above [1] to [3], wherein the first spacer layer and the second spacer layer are each made of a non-magnetic metal.
[6] The strain measurement device according to any one of above [1] to [5], wherein
   the second magnetization layer is placed on the substrate side with respect to the first magnetization layer, and
   the fourth magnetization layer is placed on the substrate side with respect to the third magnetization layer.

The gist of one embodiment of a strain measurement method of the present invention is according to the present invention that can overcome the above problems is as follows.
[7] A strain measurement method comprising:
   a step of preparing a strain measurement device including a substrate, a first element formed on the substrate and having a first magnetization layer, a second magnetization layer whose change in a magnetization direction when strain is applied to the substrate is larger than that of the first magnetization layer, and a first spacer layer placed between the first magnetization layer and the second magnetization layer, and a second element formed on the substrate and having a third magnetization layer, a fourth magnetization layer whose change in a magnetization direction when strain is applied to the substrate is larger than that of the third magnetization layer, and a second spacer layer placed between the third magnetization layer and the fourth magnetization layer, wherein, in a state where no strain is applied to the substrate, at least one magnetization direction out of the magnetization direction of the first magnetization layer, the magnetization direction of the second magnetization layer, the magnetization direction of the third magnetization layer, and the magnetization direction of the fourth magnetization layer is different from the other magnetization directions;
   a step of applying strain to the substrate;
   a step of applying a current to the first element and the second element;
   a step of measuring electrical resistance at the first element and the second element; and
   a step of subtracting or dividing one of the electrical resistance at the first element and the electrical resistance at the second element from or by the other of the electrical resistance at the first element and the electrical resistance at the second element.

The strain measurement method having the above configuration can measure strain more accurately than in the conventional art by subtracting or dividing one of electrical resistances obtained from the first element and the second element from or by the other of the electrical resistances.

Preferred aspects of the strain measurement method of the present invention are as shown in the following [8]:
[8] The strain measurement method according to above [7], further comprising a step of subtracting or dividing one of the electrical resistance at the first element and the electrical resistance at the second element from or by the other of the electrical resistance at the first element and the electrical resistance at the second element, and amplifying the resultant difference or quotient.

### Effects of the Invention

The strain measurement device and strain measurement method can measure strain more accurately than in the conventional art by subtracting or dividing one of electrical resistances obtained from the first element and the second element from or by the other of the electrical resistances.

### BRIEF DESCRIPTION OF THE DRAWINGS

FIG. 1 is a plan view of a strain measurement device according to an embodiment of the present invention.

FIG. 2 is a cross-sectional view of the strain measurement device according to an embodiment of the present invention shown in FIG. 1 taken along line II-II.

FIG. 3 is a plan view of a variant of the strain measurement device according to the embodiment of the present invention shown in FIG. 1.

FIG. 4 is a cross-sectional view of the strain measurement device according to an embodiment of the present invention shown in FIG. 3 taken along line IV-IV.

FIG. 5 represents a diagram showing configuration example of the magnetization direction of the first magnetization layer, the magnetization direction of the second magnetization layer, the magnetization direction of the third magnetization layer, and the magnetization direction of the fourth magnetization layer in the strain measurement device shown in FIG. 1.

FIG. 6 represents a diagram showing another configuration example of the magnetization direction of the first magnetization layer, the magnetization direction of the second magnetization layer, the magnetization direction of the third magnetization layer, and the magnetization direction of the fourth magnetization layer in the strain measurement device shown in FIG. 1.

FIG. 7 represents a diagram showing another configuration example of the magnetization direction of the first magnetization layer, the magnetization direction of the second magnetization layer, the magnetization direction of the third magnetization layer, and the magnetization direction of the fourth magnetization layer in the strain measurement device shown in FIG. 1.

FIG. 8 represents a diagram showing an example of the magnetization direction of the first magnetization layer, the magnetization direction of the second magnetization layer, the magnetization direction of the third magnetization layer, and the magnetization direction of the fourth magnetization layer when tensile strain is applied to the strain measurement device shown in FIG. 7.

FIG. 9 represents a graph showing an example of the magnetization direction of the first magnetization layer, the magnetization direction of the second magnetization layer, and a change in electrical resistance at a first element when tensile strain is applied to the strain measurement device shown in FIG. 7.

FIG. 10 represents a graph showing an example of the magnetization direction of the third magnetization layer, the magnetization direction of the fourth magnetization layer, and a change in electrical resistance at a second element when tensile strain is applied to the strain measurement device shown in FIG. 7.

FIG. 11 represents a graph showing the result of subtracting the electrical resistance measured at the first element from the electrical resistance measured at the second element when tensile strain is applied to the strain measurement device shown in FIG. 7.

FIG. 12 represents a circuit diagram showing a configuration example of the strain measurement device according to the embodiment of the present invention.

### DESCRIPTION OF EMBODIMENTS

The following is a specific description of the present invention with reference to the drawings. However, the prevent invention is not limited to the illustrated examples. It is also possible to implement the invention with appropriate changes to the extent that it can be adapted to the purpose of the preceding and following descriptions. All of these are included in the technical scope of the present invention.

One embodiment of the strain measurement device of the present invention has the gist of including: a substrate; a first element formed on the substrate and having a first magnetization layer, a second magnetization layer whose change in a magnetization direction, that is, amount of rotation of the magnetization direction, when strain is applied to the substrate is larger than that of the first magnetization layer, and a first spacer layer placed between the first magnetization layer and the second magnetization layer; and a second element formed on the substrate and having a third magnetization layer, a fourth magnetization layer whose change in a magnetization direction when strain is applied to the substrate is larger than that of the third magnetization layer, and a second spacer layer placed between the third magnetization layer and the fourth magnetization layer, wherein, in a state where no strain is applied to the substrate, at least one magnetization direction out of the magnetization direction of the first magnetization layer, the magnetization direction of the second magnetization layer, the magnetization direction of the third magnetization layer, and the magnetization direction of the fourth magnetization layer is different from the other magnetization directions. The strain measurement device having the above configuration can measure strain more accurately than in the conventional art by subtracting or dividing one of electrical resistances obtained from the first element and the second element from or by the other of the electrical resistances.

The overall configuration of the strain measurement device will be described with reference to FIG. 1 to FIG. 12. FIG. 1 to FIG. 8 represent configuration examples of a strain measurement device 1 having a substrate, a first element 21, and a second element 22. Hereinafter, the strain measurement device 1 is sometimes referred to simply as device 1.

The device 1 has the substrate. The shape of the substrate is not particularly limited, and the substrate can be formed into various shapes such as a columnar shape, a plate shape, and a rod shape, but it is preferable that the substrate has a plate or sheet shape as shown in FIG. 1 to FIG. 4, for example. Accordingly, it is made easier to detect even slight strain.

It is preferable that the substrate is made of a resin. In the case where the device 1 is used for sensing the movement of a human body or the like, it is preferable that the substrate is made of a flexible material. For example, polyester, polycarbonate, polyimide, etc. can be used as the material comprising the substrate. These materials may be used individually, or some of these materials may be mixed and used.

The device 1 may have only one substrate 10 as shown in FIG. 1 or may have a first substrate 11 and a second substrate 12 as shown in FIG. 3, for example. The first substrate 11 and the second substrate 12 may be made of the same material or may be made of different materials.

The device 1 has the first element 21 and the second element 22. The first element 21 and the second element 22 are formed on the substrate. The first element 21 have a first magnetization layer 21a, a second magnetization layer 21c whose change in a magnetization direction when strain is applied to the substrate is larger than that of the first magnetization layer 21a, and a first spacer layer 21b placed between the first magnetization layer 21a and the second magnetization layer 21c. The second element 22 have a third magnetization layer 22a, a fourth magnetization layer 22c whose change in a magnetization direction when strain is applied to the substrate is larger than that of the third magnetization layer 22a, and a second spacer layer 22b placed between the third magnetization layer 22a and the fourth magnetization layer 22c.

The first magnetization layer 21a, the second magnetization layer 21c, the third magnetic layer 22a and the fourth magnetic layer 22c are each made of a magnetic material. Examples of the magnetic materials forming the first magnetization layer 21a, the second magnetization layer 21c, the third magnetic layer 22a, and the fourth magnetic layer 22c include iron, cobalt, nickel, etc. These materials may be used individually, or some of these materials may be mixed and used. The first magnetization layer 21a, the second magnetization layer 21c, the third magnetic layer 22a, and the fourth magnetic layer 22c may be made of the same material or may be made of different materials.

The magnetization direction of the first magnetization layer 21a when strain is applied to the substrate is preferably within ±10°, more preferably within ±8°, and further preferably within ±5° from the magnetization direction of the first magnetization layer 21a in a state where no strain is applied to the substrate, and it is particularly preferable that the magnetization direction of the first magnetization layer 21a when strain is applied to the substrate does not change from that in a state where no strain is applied to the substrate.

Accordingly, it is made easier to improve the accuracy of strain measurement. Similarly, the magnetization direction of the third magnetization layer 22a when strain is applied to the substrate is preferably within ±10°, more preferably within ±8°, and further preferably within ±5° from the magnetization direction of the third magnetization layer 22a in a state where no strain is applied to the substrate, and it is particularly preferable that the magnetization direction of the third magnetization layer 22a when strain is applied to the substrate does not change from that in a state where no strain is applied to the substrate.

The absolute values of the magnetoelastic coupling constants of the first magnetization layer 21a and the third magnetization layer 22a are preferably close to 0MJ/m³. The magnetoelastic coupling constants of the first magnetization layer 21a and the third magnetization layer 22a are preferably 0 MJ/m³ or more and 0.5 MJ/m³ or less, more preferably 0 MJ/m³ or more and 0.3 MJ/m³ or less, further preferably 0 MJ/m³ or more and 0.1 MJ/m³ or less, and particularly preferably 0 MJ/m³.

The absolute values of the magnetoelastic coefficients of the second magnetization layer 21c and the fourth magnetization layer 22c can be set to 1 MJ/m³ or more, 3 MJ/m³ or more, 5 MJ/m³ or more, etc. The upper limits of the absolute values of the magnetoelastic coefficients of the second magnetization layer 21c and the fourth magnetization layer 22c are not particularly limited, and can be set to 20 MJ/m³, etc.

In the first element 21, it is preferable that the second magnetization layer 21c is placed on the substrate side with respect to the first magnetization layer 21a. In the first element 21, it is more preferable that the second magnetization layer 21c, the first spacer layer 21b, and the first magnetization layer 21a are arranged in this order from the substrate side, and that no other layer or member is placed between the second magnetization layer 21c, the first spacer layer 21b, and the first magnetization layer 21a. Since the second magnetization layer 21c is placed on the substrate side, it can be made easier to efficiently transmit strain to the second magnetization layer 21c, so that it can be made easier to improve the accuracy of strain measurement. Similarly, in the second element 22, it is preferable that the fourth magnetization layer 22c is placed on the substrate side with respect to the third magnetization layer 22a. In the second element 22, it is more preferable that the fourth magnetization layer 22c, the second spacer layer 22b, and the third magnetization layer 22a are arranged in this order from the substrate side, and that no other layer or member is placed between the fourth magnetization layer 22c, the second spacer layer 22b, and the third magnetization layer 22a.

The first spacer layer 21b and the second spacer layer 22b may each be made of an insulator such as silicon oxide, silicon nitride, aluminum oxide, and magnesium oxide, for example. These materials may be used individually, or some of these materials may be mixed and used.

The first spacer layer 21b and the second spacer layer 22b may be made of a nonmagnetic metal such as platinum, copper, tantalum, and gold, for example. These materials may be used individually, or some of these materials may be mixed and used. The first spacer layer 21c and the second spacer layer 22c may be made of the same material or may be made of different materials.

As shown in FIG. 1, the first element 21 and the second element 22 may be formed on the same substrate 10.

As shown in FIG. 3, the first element 21 may be formed on the first substrate 11, and the second element 22 may be formed on the second substrate 12. With this configuration, by adjusting the manner of placement of the first substrate 11 and the second substrate 12, it can be made easier to adjust a magnetization direction 31a of the first magnetization layer 21a and a magnetization direction 31c of the second magnetization layer 21c of the first element 21 and a magnetization direction 32a of the third magnetization layer 22a and a magnetization direction 32c of the fourth magnetization layer 22c of the second element 22.

Although not shown, in the case where the device 1 has two or more elements, the device 1 may be configured to have substrates whose number is equal to the number of elements, and the elements may be provided on the different substrates, respectively.

In the case where the first element 21 is formed on the first substrate 11 and the second element 22 is formed on the second substrate 12, the first substrate 11 and the second substrate 12 may be prepared in advance, and one first element 21 and one second element 22 may be formed on the substrates, respectively. Alternatively, the first element 21 and the second element 22 may be formed on one substrate and the substrate may be divided into two pieces, thereby having one first element 21 and one second element 22 on the respective substrates.

FIG. 5 to FIG. 7 are each a diagram representing, by arrows, a configuration example of the magnetization direction 31a of the first magnetization layer 21a, the magnetization direction 31c of the second magnetization layer 21c, the magnetization direction 32a of the third magnetization layer 22a, and the magnetization direction 32c of the fourth magnetization layer 22c in a state where no strain is applied to the substrate. Here, an example is shown in which the magnetization direction 31a of the first magnetization layer 21a, the magnetization direction 31c of the second magnetization layer 21c, the magnetization direction 32a of the third magnetization layer 22a, and the magnetization direction 32c of the fourth magnetization layer 22c are all parallel to the in-plane direction of the substrate. As illustrated in FIG. 5 to FIG. 7, the device 1 is configured such that in a state where no strain is applied to the substrate, at least one magnetization direction N of the magnetization direction 31a of the first magnetization layer 21a, the magnetization direction 31c of the second magnetization layer 21c, the magnetization direction 32a of the third magnetization layer 22a, and the magnetization direction 32c of the fourth magnetization layer 22c is different from other magnetization directions M.

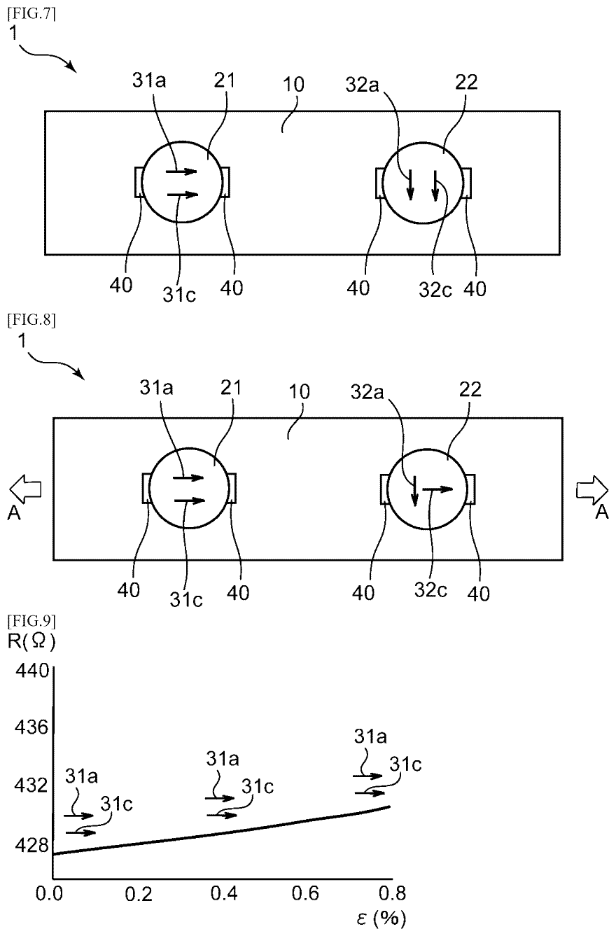

For example, as shown in FIG. 5, the device 1 may be configured such that in a state where no strain is applied to the substrate, only one magnetization direction N of the magnetization direction 31a of the first magnetization layer 21a, the magnetization direction 31c of the second magnetization layer 21c, the magnetization direction 32a of the third magnetization layer 22a, and the magnetization direction 32c of the fourth magnetization layer 22c is different from the remaining other magnetization directions M. As shown in FIG. 6 and FIG. 7, the device 1 may be configured such that in a state where no strain is applied to the substrate, two magnetization directions N of the magnetization direction 31a of the first magnetization layer 21a, the magnetization direction 31c of the second magnetization layer 21c, the magnetization direction 32a of the third magnetization layer 22a, and the magnetization direction 32c of the fourth magnetization layer 22c are different from the remaining two magnetization directions M. The device 1 may be configured such that in a state where no strain is applied to the substrate, three magnetization directions N of the magnetization direction 31a of the first magnetization layer 21a, the magnetization direction 31c of the second magnetization layer 21c, the magnetization direction 32a of the third magnetization layer 22a, and the magnetization direction 32c of the fourth magnetization layer 22c are different from the remaining one magnetization direction M. In a state where no strain is applied to the substrate, the magnetization direction 31a of the first magnetization layer 21a, the magnetization direction 31c of the second magnetization layer 21c, the magnetization direction 32a of the third magnetization layer 22a, and the magnetization direction 32c of the fourth magnetization layer 22c may all be different directions. All different directions mean, namely, that in a state where no strain is applied to the substrate, none of the magnetization direction 31c of the second magnetization layer 21c, the magnetization direction 32a of the third magnetization layer 22a, and the magnetization direction 32c of the fourth magnetization layer 22c face the same direction.

Although the above has been described using FIG. 5 to FIG. 7, those shown in FIG. 5 to FIG. 7 are examples, and the magnetization directions are not limited thereto.

As for the magnetization directions of the first magnetization layer 21a and the second magnetization layer 21c of the first element 21 and the third magnetization layer 22a and the fourth magnetization layer 22c of the second element 22 in a state where no strain is applied, the magnetization directions are usually given through the process of heating in a magnetic field followed by cooling. Thus, for example, the magnetization directions of the first magnetization layer 21a and the second magnetization layer 21c of the first element 21 and the third magnetization layer 22a and the fourth magnetization layer 22c of the second element 22 which are produced simultaneously on the same substrate are all the same in a state where no strain is applied. However, only the magnetization direction of a predetermined layer can be directed to an arbitrary direction by the following method.

For example, it is possible to perform the above method by forming two or more elements on the same substrate at once, then applying a current pulse only to a specific element, instantaneously heating the element with Joule heat while applying a magnetic field in the direction in which magnetization is to be directed, and waiting for the element to cool to room temperature. In the example in FIG. 5, the arbitrary magnetization direction is given by applying a current pulse only to the first magnetization layer 21a of the first element 21, instantaneously heating the first magnetization layer 21a with Joule heat while applying a magnetic field in the direction in which magnetization of the first magnetization layer 21a is to be directed, and waiting for the first magnetization layer 21a to cool to room temperature.

The above-described at least one magnetization direction N which is different from the magnetization directions of the other magnetization layers M intersects the other magnetization directions M preferably within ±15°, more preferably within ±10°, and further preferably within ±5° from a right angle, and particularly preferably intersects the other magnetization directions M at a right angle. Accordingly, it can be made easier to improve the accuracy of strain measurement.

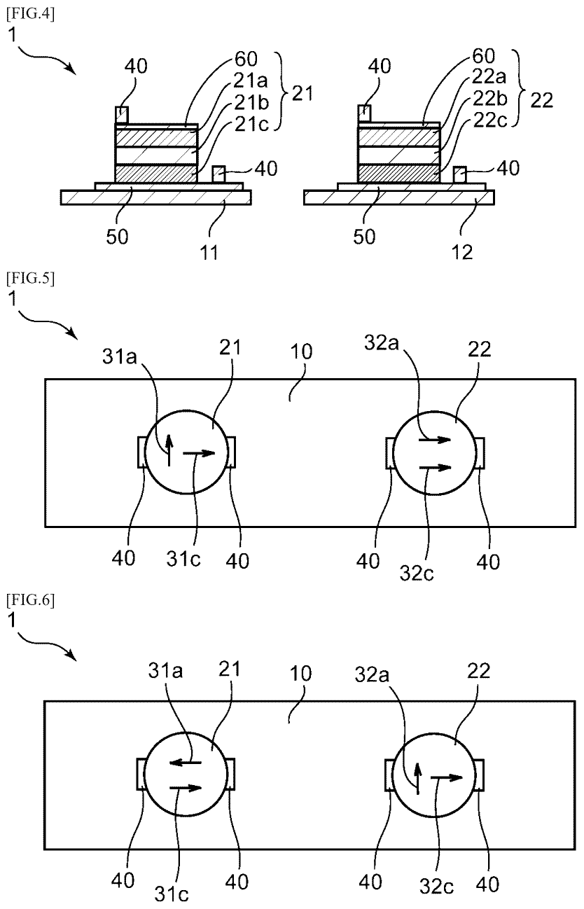

As shown in FIG. 3 and FIG. 4, base layers 50 for enhancing the adhesion with the first element 21 and the second clement 22 may be provided on the surfaces of the substrates. The base layers may be made of a nonmagnetic metal such as platinum, copper, tantalum, and gold, or an insulator such as silicon oxide, silicon nitride, aluminum oxide, and magnesium oxide, for example. These materials may be used individually, or some of these materials may be mixed and used.

As shown in FIG. 4, the first element 21 and the second element 22 may have protective layers 60 for protecting the first element 21 and the second element 22, on the surfaces of the first element 21 and the second element 22 on the side opposite to the substrate side. The protective layers may be made of a nonmagnetic metal such as platinum, copper, tantalum, and gold, for example. These materials may be used individually, or some of these materials may be mixed and used.

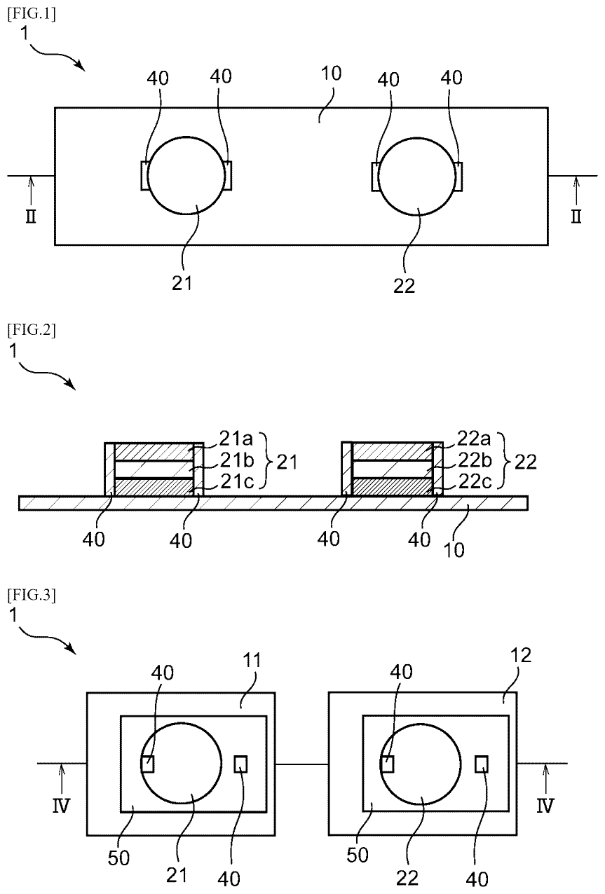

The device 1 preferably has electrodes 40 for allowing a current to flow to the first element 21 and the second element 22. As shown in FIG. 1 and FIG. 2, the electrodes 40 may be placed on the side surfaces of the first element 21 and the second element 22. As shown in FIG. 3 and FIG. 4, the electrodes 40 may be placed on the surfaces of the first element 21 and the second element 22 on the side opposite to the substrate side and on the base layer 50.

The strain measurement device 1 according to the embodiment of the present invention has been described so far. Next, a strain measurement method according to an embodiment of the present invention will be described.

First, the strain measurement device 1 according to the embodiment of the present invention described above is prepared.

Next, strain is applied to the substrate of the prepared strain measurement device. In the case where the first element 21 and the second element 22 are formed on the same substrate 10 as shown in FIG. 1, strain is applied to the substrate 10. In the case where the first element 21 is formed on the first substrate 11 and the second element 22 is formed on the second substrate 12 as shown in FIG. 3, strain is applied to the first substrate 11 and the second substrate 12. For example, if the magnetization direction 31a of the first magnetization layer 21a, the magnetization direction 31c of the second magnetization layer 21c, the magnetization direction 32a of the third magnetization layer 22a, and the magnetization direction 32c of the fourth magnetization layer 22c of the first element 21 and the second element 22 shown in FIG. 1 are the magnetization directions shown in FIG. 7, the magnetization direction 32c of the fourth magnetization layer 22c changes when tensile strain is applied to the substrate 10 in the direction of an arrow A as shown in FIG. 8. If the magnetization direction 32c of the fourth magnetization layer 22c changes, the electrical resistance at the second element 22 also changes. FIG. 8 shows an example in which the magnetization direction 32c of the fourth magnetization layer 22c rotates on a plane parallel to the in-plane direction.

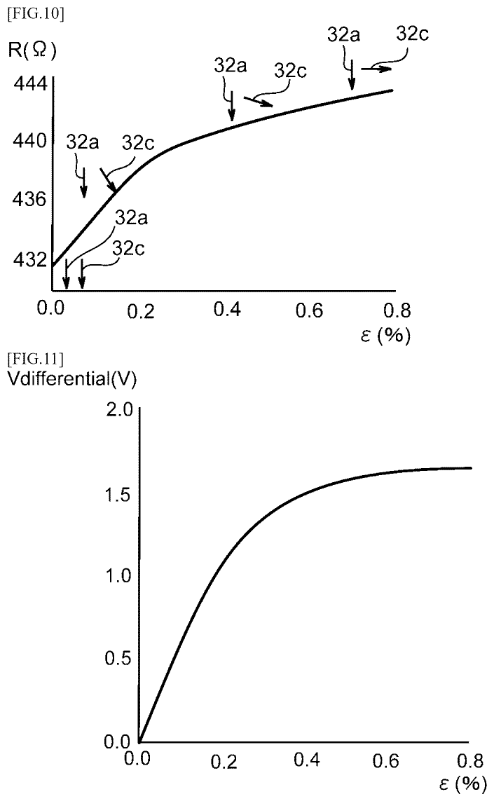

To detect the change in electrical resistance associated with the change in magnetization direction as described above, a current is applied to the first element 21 and the second element 22 of the strain measurement device 1. For example, a current can be applied via the electrodes 40 shown in FIG. 1 and FIG. 2. Then, the electrical resistance at the first element 21 and the second element 22 is measured. For example, the electrical resistance can be measured via the electrodes 40 shown in FIG. 1 and FIG. 2. FIG. 9 shows the change in electrical resistance at the first element 21 when tensile strain is applied to the substrate 10 in the direction of the arrow A as shown in FIG. 8. At the first magnetization layer 21a and the second magnetization layer 21c of the first element 21, no change in magnetization direction occurs, and thus only a change in electrical resistance caused by the tensile strain appears. FIG. 10 shows the change in electrical resistance at the second element 22 when tensile strain is applied to the substrate 10 in the direction of the arrow A and the magnetization direction 32c of the fourth magnetization layer 22c changes as shown in FIG. 8. At the second element 22, the magnetization direction 32c of the fourth magnetization layer 22c changes, and thus a change in electrical resistance caused by the tensile strain and a change in electrical resistance caused by the change in magnetization direction appear.

One of the electrical resistance at the first element 21 and the electrical resistance at the second element 22 which are measured as described above is subtracted or divided from or by the other of the electrical resistance at the first element 21 and the electrical resistance at the second element 22. In the above example, by subtracting or dividing the electrical resistance measured at the first element 21 from or by the electrical resistance measured at the second element 22, the change in electrical resistance caused by the change in magnetization direction can be derived. The result of subtracting the electrical resistance measured at the first element 21 from the electrical resistance measured at the second element 22 is shown in FIG. 11 as a graph. This allows the degree of strain occurring to be measured. As an example of the strain to be measured, tensile strain is exemplified above, but the strain that can be measured is not limited to tensile strain, and may be compressive strain, for example. If the strain to be measured is compressive strain, compressive strain is applied to the substrate.

As described above, the strain measurement method according to an embodiment of the present invention can measure strain more accurately than in the conventional art by subtracting or dividing one of electrical resistances obtained from the first element and the second clement from or by the other of the electrical resistances.

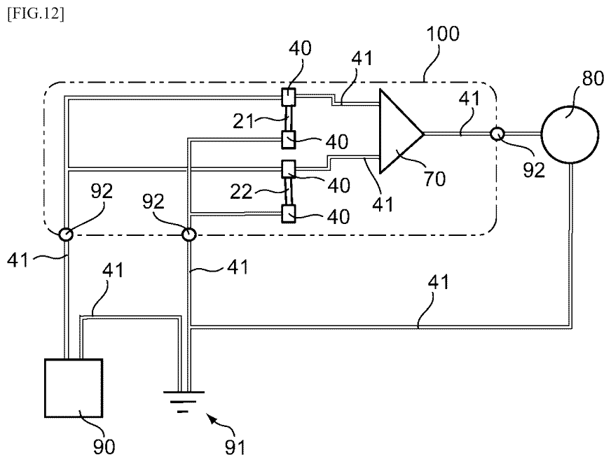

The above strain measurement method preferably includes a step of subtracting or dividing one of the electrical resistance at the first element 21 and the electrical resistance at the second element 22 from or by the other of the electrical resistance at the first element 21 and the electrical resistance at the second element 22, and amplifying the resultant difference or quotient. The above strain measurement method may include a step of subtracting one of the electrical resistance at the first element 21 and the electrical resistance at the second element 22 from the other of the electrical resistance at the first element 21 and the electrical resistance at the second element 22, and amplifying the resultant difference. For example, this can be implemented by connecting a differential amplifier to the first element 21 and the second element 22 via the electrodes 40 shown in FIG. 1 and FIG. 2. FIG. 12 shows an example of a specific circuit diagram including a differential amplifier 70. A portion encircled by an alternate long and two short dashes line is a three-terminal strain gauge 100. Accordingly, the change in electrical resistance caused by the change in magnetization direction can be rapidly derived, so that strain can be measured more quickly.

This application claims the benefit of the priority date of Japanese patent application No. 2021-198498 filed on Dec. 7, 2021. All of the contents of the Japanese patent application No. 2021-198498 filed on Dec. 7, 2021 are incorporated by reference herein.

### REFERENCE SIGNS LIST

1: strain measurement device
10: substrate
11: first substrate
12: second substrate
21: first element
21a: first magnetization layer
31a: magnetization direction of the first magnetization layer
21b: first spacer layer
21c: second magnetization layer
31c: magnetization direction of the second magnetization layer
22: second element
22a: third magnetization layer
32a: magnetization direction of the third magnetization layer
22b: second spacer layer
22c: fourth magnetization layer
32c: magnetization direction of the fourth magnetization layer
40: electrode
41: wire
50: base layer
60: protective layer
70: differential amplifier
80: voltmeter
90: power supply device
91: earth
92: terminal
100: three-terminal strain gauge

1. A strain measurement device comprising:
a substrate;
a first element formed on the substrate and having a first magnetization layer, a second magnetization layer whose change in a magnetization direction when strain is applied to the substrate is larger than that of the first magnetization layer, and a first spacer layer placed between the first magnetization layer and the second magnetization layer; and
a second element formed on the substrate and having a third magnetization layer, a fourth magnetization layer whose change in a magnetization direction when strain is applied to the substrate is larger than that of the third magnetization layer, and a second spacer layer placed between the third magnetization layer and the fourth magnetization layer, wherein
in a state where no strain is applied to the substrate, at least one magnetization direction out of the magnetization direction of the first magnetization layer, the magnetization direction of the second magnetization layer, the magnetization direction of the third magnetization layer, and the magnetization direction of the fourth magnetization layer is different from the other magnetization directions.

2. The strain measurement device according to claim 1, wherein
the magnetization direction of the first magnetization layer when strain is applied to the substrate is within ±10° from the magnetization direction of the first magnetization layer when no strain is applied to the substrate, and
the magnetization direction of the third magnetization layer when strain is applied to the substrate is within ±10° from the magnetization direction of the third magnetization layer when no strain is applied to the substrate.

3. The strain measurement device according to claim 1, wherein the at least one magnetization direction perpendicularly intersects the other magnetization directions.

4. The strain measurement device according to claim 1, wherein the first spacer layer and the second spacer layer are each made of an insulator.

5. The strain measurement device according to claim 1, wherein the first spacer layer and the second spacer layer are each made of a non-magnetic metal.

6. The strain measurement device according to claim 1, wherein
the second magnetization layer is placed on the substrate side with respect to the first magnetization layer, and
the fourth magnetization layer is placed on the substrate side with respect to the third magnetization layer.

7. A strain measurement method comprising:
a step of preparing a strain measurement device including a substrate, a first element formed on the substrate and having a first magnetization layer, a second magnetization layer whose change in a magnetization direction when strain is applied to the substrate is larger than that of the first magnetization layer, and a first spacer layer placed between the first magnetization layer and the second magnetization layer, and a second element formed on the substrate and having a third magnetization layer, a fourth magnetization layer whose change in a magnetization direction when strain is applied to the substrate is larger than that of the third magnetization layer, and a second spacer layer placed between the third magnetization layer and the fourth magnetization layer, wherein, in a state where no strain is applied to the substrate, at least one magnetization direction out of the magnetization direction of the first magnetization layer, the magnetization direction of the second magnetization layer, the magnetization direction of the third magnetization layer, and the magnetization direction of the fourth magnetization layer is different from the other magnetization directions;
a step of applying strain to the substrate;
a step of applying a current to the first element and the second element;
a step of measuring electrical resistance at the first element and the second element; and
a step of subtracting or dividing one of the electrical resistance at the first element and the electrical resistance at the second element from or by the other of the electrical resistance at the first element and the electrical resistance at the second element.

8. The strain measurement method according to claim 7, further comprising a step of subtracting or dividing one of the electrical resistance at the first element and the electrical resistance at the second element from or by the other of the electrical resistance at the first element and the electrical resistance at the second element, and amplifying the resultant difference or quotient.

9. The strain measurement device according to claim 1, wherein
in a state where no strain is applied to the substrate, the magnetization direction of the second magnetization layer is different from the magnetization direction of the fourth magnetization layer.

10. The strain measurement device according to claim 1, wherein
the magnetoelastic coupling constants of the first magnetization layer and the third magnetization layer are 0 MJ/m³ or more and 0.5 MJ/m³ or less, and
the absolute values of the magnetoelastic coefficients of the second magnetization layer and the fourth magnetization layer are 1 MJ/m³ or more and 20 MJ/m³ or less.

11. The strain measurement method according to claim 7, wherein
in a state where no strain is applied to the substrate, the magnetization direction of the second magnetization layer is different from the magnetization direction of the fourth magnetization layer.

12. The strain measurement method according to claim 7, wherein
the magnetoelastic coupling constants of the first magnetization layer and the third magnetization layer are 0 MJ/m³ or more and 0.5 MJ/m³ or less, and
the absolute values of the magnetoelastic coefficients of the second magnetization layer and the fourth magnetization layer are 1 MJ/m³ or more and 20 MJ/m³ or less.
